(19) United States
(12) Patent Application Publication
(10) Pub. No.: US 2026/0106451 A1
(43) Pub. Date: Apr. 16, 2026

(54) SURGE PROTECTION DEVICE, MOV WITH INTEGRATED SHORT CIRCUIT PROTECTION, INSERTION SYSTEM AND ARC SHIELD

(71) Applicant: MERSEN USA EP CORP., Boonton, NJ (US)

(72) Inventors: Toni COSTA, Barcelona (ES); Sergio NUNEZ, Barcelona (ES); Victor LOPEZ, Barcelona (ES); German BALADA, Barcelona (ES); Jordi COMELLAS, Barcelona (ES)

(73) Assignee: MERSEN USA EP CORP., Boonton, NJ (US)

(21) Appl. No.: 19/116,829

(22) PCT Filed: Sep. 20, 2023
(86) PCT No.: PCT/US2023/033217

§ 371 Date: Mar. 28, 2025

Related U.S. Application Data
(60) Provisional application No. 63/411,962, filed on Sep. 30, 2022.

(51) Int. Cl. H02H 9/04

(52) U.S. Cl. CPC H02H 9/044

(57) ABSTRACT

A cartridge system that is insertable into a base member and operative to complete an electrical circuit through the base member includes an insertion and extraction system for selectively locking the cartridge to the base member, where the insertion and extraction system is integrally formed with a support member of the cartridge. The cartridge system may also include an arc shield for suppressing an arc between electrodes, and a protection element that includes an integrally formed electrode having a weak region that acts as a disconnect means.

### FIELD OF THE INVENTION

The present invention relates generally to circuit protection and monitoring devices, and more particularly to a cartridge insertion and removal system for circuit protection and monitoring devices, an arc shield for suppressing an arc in circuit protection and monitoring devices, and protection means for voltage clamping devices in circuit protection and monitoring devices.

### BACKGROUND OF THE INVENTION

Many of today's highly sensitive electronic components, such as computer and computer-related equipment that are used in commercial and residential applications contain circuit protection devices. These devices protect sensitive and/or expensive electronic circuits and components from damage from various fault conditions, such as voltage surges/spikes.

A commonly used device to protect against voltage surges/spikes is a metal-oxide varistor (MOVs), which is connected in parallel between a service power line and a ground or neutral line, or between a neutral line and a ground line. MOVs are non-linear, electronic devices made of ceramic-like materials comprising zinc-oxide grains and a complex amorphous inner granular material. Over a wide range of current, the voltage remains within a narrow band commonly called the varistor voltage. A log-log plot of the instantaneous voltage in volts versus the instantaneous current in amps yields a nearly horizontal line. It is this unique current-voltage characteristic that makes MOVs ideal devices for protection of sensitive electronic circuits against electrical surges, over-voltages, faults or shorts.

When exposed to voltages exceeding their voltage value, MOVs become highly conductive devices that absorb and dissipate the energy related to the overvoltage and simultaneously limit dump current to a neutral line or ground plane. If an over-voltage condition is not discontinued, the MOVs will continue to overheat and can ultimately fail catastrophically, i.e., rupture or explode. Such catastrophic failure may destroy the sensitive electronic equipment and components in the vicinity of the MOVs. The destruction of electrical equipment or components in the electrical distribution system can disrupt power to buildings or floors for prolonged periods of time until such components are replaced or repaired. Moreover, the failure of the MOVs in a surge suppression system may allow the fault condition to reach the sensitive electronic equipment the system was designed to protect.

### SUMMARY OF THE INVENTION

According to one aspect of the invention, a voltage suppression device for suppressing voltage surges in an electrical circuit includes an overvoltage clamping element having a first electrode and a second electrode, the first electrode and the second electrode operative to pass power through the overvoltage clamping element, wherein at least one electrode of the first electrode or the second electrode includes a region having reduced cross-section relative to other regions of the respective electrode.

In one embodiment, the at least one electrode is integrally formed with the overvoltage clamping element.

In one embodiment, the overvoltage clamping element and the at least one electrode are formed as a unitary structure.

In one embodiment, in response to a current through the at least electrode exceeding a predetermined threshold current the region of reduced cross section electrically disconnects a portion of the at least one electrode from another portion of the at least one electrode.

In one embodiment, the overvoltage clamping element includes a varistor, gas discharge tube, spark gap, or diode.

In one embodiment, the overvoltage clamping element has a first planar side and a second planar side opposing the first planar side, and the first electrode is connected to the first planar side and the second electrode is connected to the second planar side.

In one embodiment, the at least one electrode includes a connection region for electrically connecting the at least one electrode to another device, and the region of reduced cross section is arranged between the connection region and a body of the overvoltage clamping element.

In one embodiment, the overvoltage clamping element includes at least one of a disk-shape, a rectangular shape or a cylindrical shape.

According to another aspect of the invention, an arc shield for suppressing an electrical arc includes: a support member including a wall; a mount arranged on the wall, the mount configured to receive an electrode to be shielded; and a shield attached to the support member and movable relative to the support member between a first position and a second position, wherein when the shield is in the second position the electrode is enclosed by the shield and the wall.

In one embodiment, the shield includes a first hood part mounted on a slider and a second hood part mounted on a rotatable member, the slider and the rotatable member independent from one another, wherein the slider is attached to the support member and movable relative to the support member between a first slider position and a second slider position, and the rotatable member is attached to the support member and rotatable between a first angular position and a second angular position.

In one embodiment, the slider is configured to move linearly between the first position and the second position.

In one embodiment, movement of the slider causes corresponding movement of the rotatable member.

In one embodiment, the rotatable member includes an arcuate surface and the slider includes a ramp portion that cooperates with the arcuate surface, and movement of the slider causes the ramp portion apply a force to the arcuate surface and push the rotatable member about an axis of rotation of the rotatable part.

In one embodiment, the rotatable member includes a mechanical stop configured to limit an angular orientation of the rotatable member.

In one embodiment, the slider includes a first catch member and the rotatable member includes a second catch member, the first catch member and the second catch member configured to cooperate with each other to prevent rotation of the rotatable member when the slider is in the first position.

In one embodiment, the second hood part includes a first wall, a second wall, and a sidewall joining the first wall to the second wall, wherein the first wall and the second wall are non-parallel to each other.

In one embodiment, the first hood part includes a first wall, a second wall opposing the first wall, and a sidewall joining the first wall to the second wall.

In one embodiment, the arc shield includes a biasing member coupled to the shield, the biasing member operative to bias the shield toward the second position.

According to another aspect of the invention, a cartridge system insertable into a base member and operative to complete an electrical circuit through the base member, the cartridge system includes: a cartridge support member; a retainer integrally formed with the support member and including a latch and an actuator, wherein displacement of the actuator produces corresponding displacement of the latch; and a housing including an opening, wherein the support member is contained within the housing and the actuator is accessible through the opening.

In one embodiment, the cartridge system includes the voltage suppression device as described herein, wherein the voltage suppression device is mounted on the cartridge support member.

In one embodiment, the cartridge system includes a first cartridge terminal and a second cartridge terminal, the first and second cartridge terminals extending out from the cartridge support member, wherein when the cartridge member is secured to a base member the first and second cartridge terminals electrically complete a circuit through the base member.

In one embodiment, the cartridge system includes a thermal disconnector mechanism positioned in a ready configuration, wherein one of the first or second electrodes of the overvoltage clamping element is electrically connected to one of the first or second cartridge terminals of the cartridge member via the thermal disconnector mechanism, the thermal disconnector mechanism being repositionable to electrically disconnect the one of the first or second electrodes of the overvoltage clamping element from the respective first or second cartridge terminals, the thermal disconnector mechanism including: a biased conductor elastically deflected and electrically connected to the one of the first or second electrodes of the overvoltage clamping element in the ready configuration; a solder securing the biased conductor in electrical connection with the one of the first or second electrodes of the overvoltage clamping element in the ready configuration; wherein the solder is meltable in response to overheating of the overvoltage clamping element; and wherein the biased conductor is configured to electrically disconnect the one of the first or second electrodes of the overvoltage clamping element from the respective first or second cartridge terminals when the solder is melted.

In one embodiment, the cartridge system includes the arc shield as described herein, wherein the cartridge support member includes the support member of the arc shield.

In one embodiment, when the biased conductor electrically disconnects the one of the first or second electrodes of the overvoltage clamping element the slider moves to the second position and the rotatable member moves to the second angular position to enclose the one of the first or second electrodes of the overvoltage clamping element within the first hood part, the second hood part and the wall.

In one embodiment, the cartridge support member includes a first sidewall and a second sidewall opposing the first sidewall, and the actuator includes a first grip part and a second grip part attached to the first sidewall and the second sidewall, respectively.

In one embodiment, the opening includes a first opening and a second opening, and the first and second grip parts extend out of the first and second openings, respectively.

In one embodiment, the latch includes a first latch part and a second latch part, the first latch part and the second latch part attached to the first and second grip parts, respectively.

In one embodiment, the cartridge system includes the base member.

In one embodiment, the base member includes: a base support configured to receive the cartridge member; a receiver arranged on the base support, said receiver cooperative with the latch to selectively secure the cartridge member to the base member; wherein the actuator is operative to displace the latch to release the latch from the receiver and enable the cartridge member to be released from the base member.

In one embodiment, the cartridge system includes the base member includes a first connection terminal and a second connection terminal for connection to an electric circuit, and a first base terminal and a second base terminal electrically connected to the first connection terminal and the second connection terminal, respectively, and wherein when the cartridge member is secured to the base member the first and second cartridge terminals electrically connect to the first and second base terminals, respectively.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention may take physical form in certain parts and arrangement of parts, an embodiment of which is described in detail in the specification and illustrated in the accompanying drawings, wherein:

FIGS. 1A-1D are perspective views of a cartridge inserted into a base member, a cartridge member, a front view of a base member and a rear view of the base member, respectively;

FIG. 2A is a front view of an exemplary cartridge member in accordance with an embodiment of the invention in the ready state;

FIG. 2B is a rear view of the cartridge member of FIG. 2A;

FIG. 2C is a left side view of the cartridge member of FIG. 2A;

FIG. 2D is a right side view of the cartridge member of FIG. 2A;

FIG. 2E is a top view of the cartridge member of FIG. 2A;

FIG. 2F is a bottom view of the cartridge member of FIG. 2A;

FIGS. 3A-3B are front and rear perspective views of an exemplary voltage suppression device that includes an electrode in accordance with the invention;

FIG. 3C is a close-up view of the electrode in FIG. 3A;

FIGS. 3D-3E are front and rear perspective views of another exemplary voltage suppression device that includes an electrode in accordance with the invention;

FIG. 4A is a side view of a cartridge member in accordance with the invention in the tripped state just after the solder has melted and prior to movement of the slider and arc shield;

FIG. 4B is a side view of a cartridge member in accordance with the invention in the tripped/protected state;

FIGS. 5A and 5B are side perspective and side views, respectively, of an exemplary slider in accordance with the invention;

FIG. 6A is a perspective view of an exemplary rotating member in accordance with an embodiment of the invention; and

FIG. 6B is a side view of an exemplary rotating member in accordance with an embodiment of the invention.

### DETAILED DESCRIPTION OF THE INVENTION

Embodiments of the present invention will now be described with reference to the drawings, wherein like reference numerals are used to refer to like elements throughout. It will be understood that the figures are not necessarily to scale.

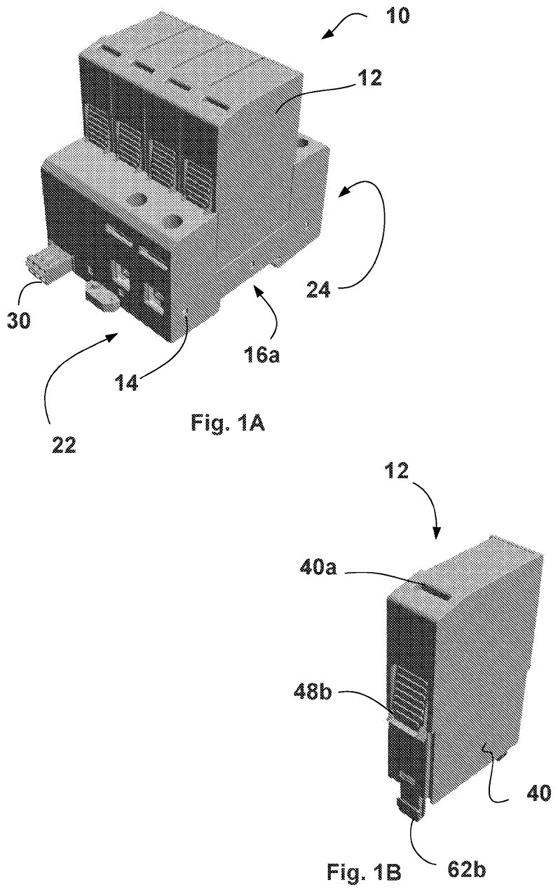

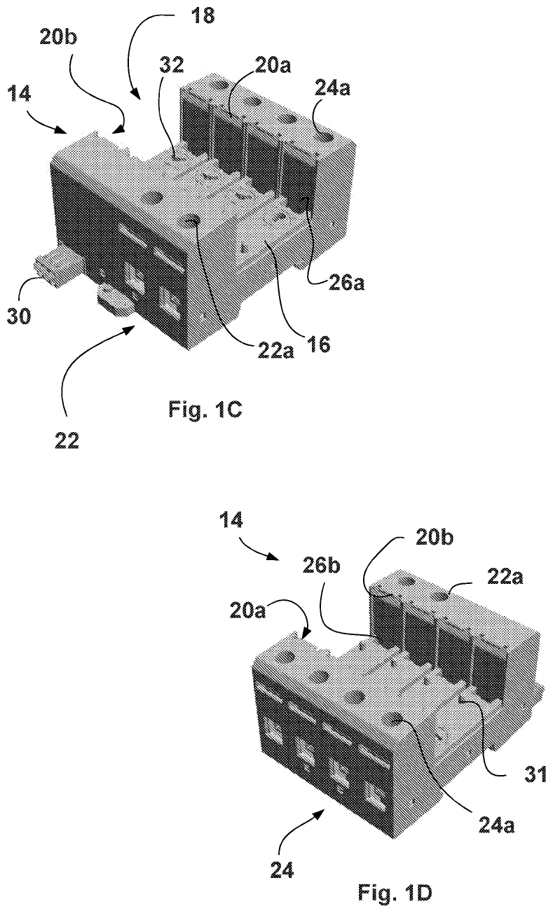

Referring initially to FIGS. 1A-1D, illustrated are a cartridge member 12 and a base member 14 that employ an insertion and extraction system 10 in accordance with embodiments of the invention. FIG. 1A illustrates four cartridge members 12 inserted into the base member 14, FIG. 1B is a front perspective view of the cartridge member 12, and FIGS. 1C and 1D are front and rear perspective views of the base member 14. As seen in FIG. 1A, the cartridge member 12 is inserted into the base member 14 and selectively secured thereto via the insertion and extraction means as described in more detail below.

The base member 14 includes a support structure 16, which in the illustrated embodiment is in the form of a frame with a cover attached to the frame, to which other components of the base member 14 may be attached. In the illustrated embodiment, the support structure 16 includes channel 18 for receiving one or more cartridge members 12, the channel 18 having a width that corresponds to a width of a cartridge member 12 and a length that corresponds to a multiple of the length of the cartridge member 12. For example, in FIG. 1A the base member 14 is dimensioned to receive four cartridge members 12 and thus the length of the channel 18 is four times the length of a cartridge member 12. A bottom side of the support structure 16 includes a channel 16a for mounting to a DIN rail, as is conventional. Receivers 20a, 20b are arranged on opposing sides of the support structure 16, the receivers 20a, 20b cooperative with a latch of the cartridge member 12 to selectively secure the cartridge member 12 to the base member 14, as described in further detail below. In the illustrated embodiment, the receivers 20a, 20b are in the form of horizontal slots or grooves arranged below a surface of the U-shaped channel 18.

The base member 14 further includes one or more first (e.g., ground) connection terminals 22 and one or more second (e.g., power) connection terminals 24 for connection to an electric circuit that is to be protected or monitored. The first and second connection terminals 22, 24 may be clamping terminals or other terminals as known in the art. Fasteners (not shown) for securing electrical conductors to the first and second connection terminals 22, 24 can be accessed via access holes 22a, 24a, each access hole corresponding to a respective fastener of the terminal. Electrically connected to the first connection terminal 22 and the second connection terminal 24 are one or more first base terminals 26a and one or more second base terminals 26b, respectively. The first and second base terminals 26a, 26b electrically connect to respective terminals of the cartridge member 12 as described in more detail below.

The base member 14 may optionally include an electrical connector 30 for connection to a remote device, such as a monitoring device. The electrical connector 30 enables a status of the base member 14 and/or of the cartridge members 12 inserted into the base member 14 to be remotely reported. For example, each cartridge member 12 and/or the base member 14 may include a switch (not shown) having contacts that provide a signal indicative of a status of the cartridge member 12 or the base member 14, e.g., closed contacts indicate normal operation and open contacts indicate abnormal condition. Terminals of the electrical connector 30 are electrically connected to the respective contacts via internal conductors (not shown) of the base member 14, and external conductors (not shown) can connect the electrical connector 30 (and thus the respective contacts) to a monitoring device that monitors a status of the cartridge members 12 and/or base member 14. A plunger 31 corresponding to each cartridge member 12 can be arranged in the slot 18, the plunger 31 movable relative to the base member 14 to actuate the switch. The plunger 31 cooperates with an actuator in the cartridge member 12 as described in more detail below to provide a status of the respective cartridge member 12.

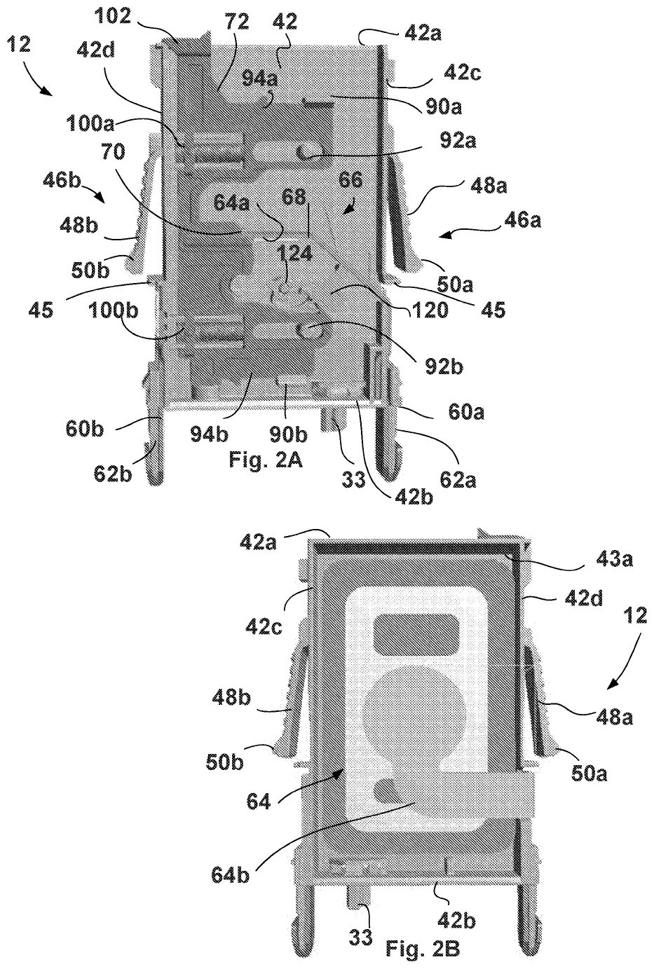

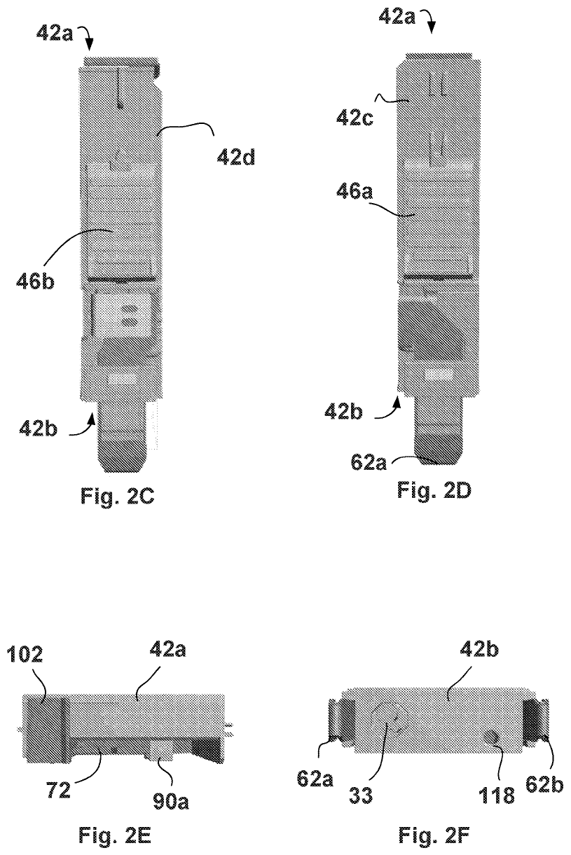

The base member 14 may optionally include a key slot 32 indicative of a rating of the circuit to which the base member is connected. A corresponding key 33 (FIGS. 2A, 2B) of the cartridge member 12 cooperates with the key slot 32 to enable or reject insertion of the cartridge member 12 into the base member 14. Thus, if user attempts to insert a cartridge member 12 having an incorrect rating or configuration into a specific slot of the base member 14, the key 33 of the cartridge member 12 will be rejected by the key slot 32 of the base member 14 and hence the cartridge member 12 cannot be inserted into that specific slot of the base member 14.

With continued reference to FIG. 1B and additional reference to FIGS. 2A-F, illustrated are a front, back, left-side, right-side, top and bottom views of an exemplary cartridge member 12 with the housing 40 removed (FIG. 1B shows the cartridge member 12 with the housing 40). The cartridge member 12 includes a cartridge support 42 to which components of the cartridge member 12 are attached, wherein when assembled the support 42 resides within the housing 40. The support includes a top wall 42a, a bottom wall 42b, and opposing sidewalls 42c, 42d. One or more retention devices 46a, 46b are attached to or formed integral with each sidewall 42c, 42d, the retention devices 46a, 46b including elastically deformable actuators 48a, 48b. Each actuator 48a, 48b includes a respective latch 50a, 50b arranged at a bottom region of the respective actuator. While the illustrated embodiment includes an actuator and latch at each sidewall, a single latch arranged only at one sidewall is possible.

When the housing 40 is attached to the support 42, the actuators 48a, 48b are accessible from outside the housing 40, while the latches 50a, 50b are secured within the receivers 20a, 20b. In this regard, the actuators 48a, 48b, which can be formed as grips having ridges or other means to minimize slip when grasped by a user, can be pressed from outside the housing 40 and/or extend outside the housing 40. Movement of the actuators 48a, 48b results in corresponding movement of the latches 50a, 50b. The latches 50a, 50b cooperate with the receivers 20a, 20b of the base member 14 to selectively lock/release the cartridge member 12 to/from the base member 14. More specifically, as a user applies an inward force to the actuators 48a, 48b, the actuators deform causing the latches 50a, 50b to be displaced inward and released from the respective receiver 20a, 20b of the base member 14, which enables the cartridge member 12 to be released and removed from the base member 14. Similarly, when the user removes the applied force, the actuators 48a, 48b return to their normal state and cause the latches 50a, 50b to engage the respective receivers 20a, 20b. When the cartridge member 12 is inserted and secured to the base member 14, only the actuators 48a, 48b are accessible outside the housing (and in the illustrated embodiment the actuators 48a, 48b extend thorough the housing 40), with all other components enclosed by the housing 40 and/or the base member 14. Isolators 45 isolate cartridge terminals 62a, 62b from a user as the user grasps/presses the actuators 48a, 48b.

The cartridge member 12 further includes a pair of elongated legs 60a, 60b extending downward from the bottom wall 42b, each leg having a respective cartridge terminal 62a, 62b attached thereto and wrapped around the respective leg 60a, 60b. Elongated legs 60a, 60b control the maximum deformation of the cartridge terminals 62a, 62b once inserted into the base member 14 and compressed by the base terminals 26a, 26b. In the illustrated embodiment, cartridge terminal 62b is connected to electrode 64b of a protection or monitoring device 64 that is disposed on the backside of the support 42, while cartridge terminal 62a is connected to electrode 64a of the protection or monitoring device 64 through a thermal disconnector mechanism 66 on the front side of the support 42. Further, in the illustrated embodiment a protection device 64 (e.g., a surge protection device (SPD)) is mounted on the backside of the support 42 and thus features of the invention will be described chiefly in the context of a voltage suppression device. It will be appreciated, however, that any shape (rectangular, square, cylindrical, disk shape, etc.) and type of protection device and/or monitoring device may be employed in place of or in combination with the voltage clamping element without departing from the scope of the invention.

The thermal disconnector mechanism 66 includes a biased conductor 68 having a first end that, in the ready configuration, is electrically connected to the first electrode 64a of the voltage suppression device 64, which is best seen in FIG. 2b, and a second end electrically connected to cartridge terminal 62a. A thermal weld utilizing solder secures the biased conductor 68 in electrical connection with the first electrode 64a of the voltage suppression device 64 when in the ready configuration, where the solder is meltable in response to overheating of the voltage suppression device 64. According to one embodiment, the solder is operative to withstand temperatures up to approximately 180-190 degrees C before melting. The biased conductor 68 includes a lip or ridge 70 formed at the first end, the lip 70 operative to hold a slider 72 in a ready position as described in more detail below. The thermal disconnector mechanism 66 is repositionable to electrically disconnect the first electrode 64a of the voltage suppression device 64 from the first cartridge terminal 62a in response to heat from the voltage suppression device melting the solder. Upon the solder melting, the biased conductor 68 moves away from the first electrode 64a of the voltage suppression device 64 thereby disconnecting it from the first cartridge terminal 62a.

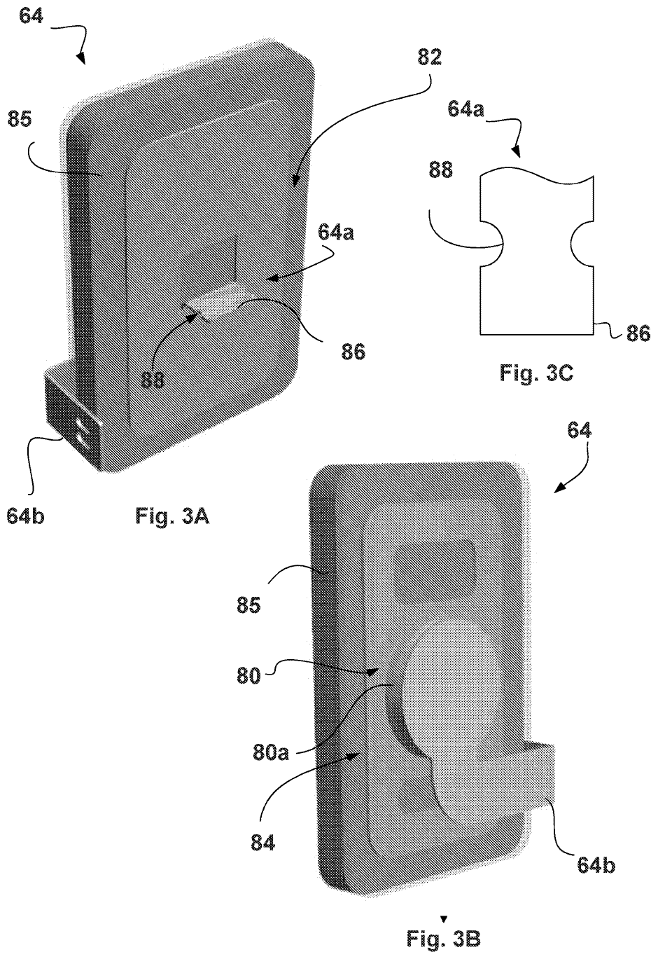

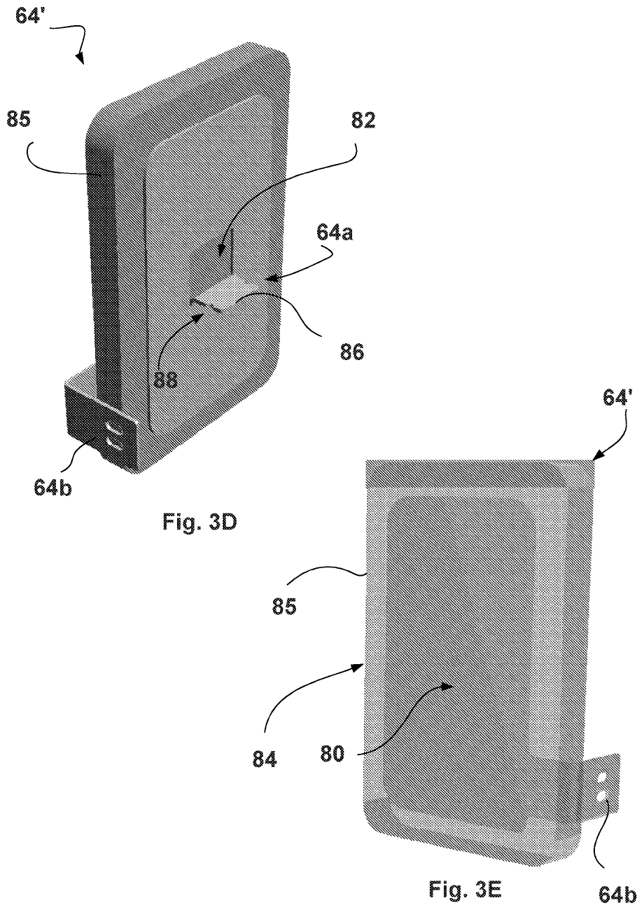

Referring briefly to FIGS. 3A-3B, illustrated are front and rear perspective views of an exemplary voltage suppression device 64 in accordance with an embodiment of the invention. The voltage suppression device 64 includes an overvoltage clamping element 80 in the form of a varistor (not seen in FIGS. 3A and 3B) electrically in series with a gas discharge tube 80a. It will be appreciated, however, that other configurations are possible, e.g., single or multiple varistors, single or multiple gas discharge tubes, a spark gap or the like. The voltage suppression device 64 has a first planar side 82 and a second planar side 84 opposing the first planar side 82. In the illustrated embodiment the overvoltage clamping element 80 is mounted both within and on a support structure 85 (i.e., a varistor is arranged within the support structure 85 and a gas discharge tube 80a is arranged on the support structure). A first electrode 64a is arranged on the first planar side 82 of the voltage suppression device 64 and electrically connected to a first electrode of the varistor, and the second electrode 64b is arranged on the second planar side 84 of the voltage suppression device 64 and electrically connected to a first electrode of the gas discharge tube, where the second electrodes of the varistor and the gas discharge tube are electrically connected to each other. The first electrode 64a and a second electrode 64b are operative to pass power through the overvoltage clamping element 80.

As seen in FIG. 3A and with additional reference to FIG. 3C, a distal end of the first electrode 64a includes a connection region 86 for connecting the voltage suppression device 64 to a circuit, and a weak region 88, e.g., a region having reduced cross-section relative to other regions of the first electrode. The weak region 88 is formed between the connection region 86 and a body of the overvoltage clamping element 80 (e.g., between the connection region 88 and a body of the varistor within the support structure 85). The weak region 88 acts as a disconnect means in the event a primary disconnect means (e.g., the thermal disconnect mechanism) fails to operate or operates too slow. More particularly, in response to a current through the electrode 64a exceeding a threshold current, the weak region 88 electrically disconnects a portion of the electrode 64a immediately adjacent to first planar side 82 the from the connection region 86. Such disconnect action, for example, can be due to the reduced cross section relative to other regions of the electrode and/or the use of a different type of conductor in the weak region, which will melt much sooner than the other regions and disconnect the overvoltage clamping element 80 (and thus the voltage suppression device 64) from the connection region 88 and thus any circuit connected to the connection region 86.

Accordingly, the weak region 88 acts as a protection element that is integrated within the voltage suppression device 64. In this regard, the electrode having the weak region 88 is integrally formed with the overvoltage clamping element 80 of the voltage suppression device 64, e.g., the overvoltage clamping element 80 and the electrode 64a with the weak region 88 are formed as a unitary structure.

Referring briefly to FIGS. 3D and 3E, illustrated is another embodiment of a voltage suppression device 64′ in accordance with the invention. The voltage suppression device 64′ is substantially the same as the voltage suppression device 64 of FIGS. 3A and 3B, but only includes a voltage clamping element 80 in the form of a varistor arranged with the support structure 85 (i.e., the voltage suppression device 64′ does not include a gas discharge tube). Importantly, the voltage suppression device 64′, like the embodiment of FIGS. 3A and 3B, includes an electrode 64a having a weak region 88 arranged between a connection region 86 and a body of the overvoltage clamping element 80 (e.g., between the connection region 88 and a body of the varistor within the support structure 85), where the electrode having the weak region 88 is integrally formed with the overvoltage clamping element 80 (the weak region is integrally formed within the electrode of the overvoltage clamping element 80).

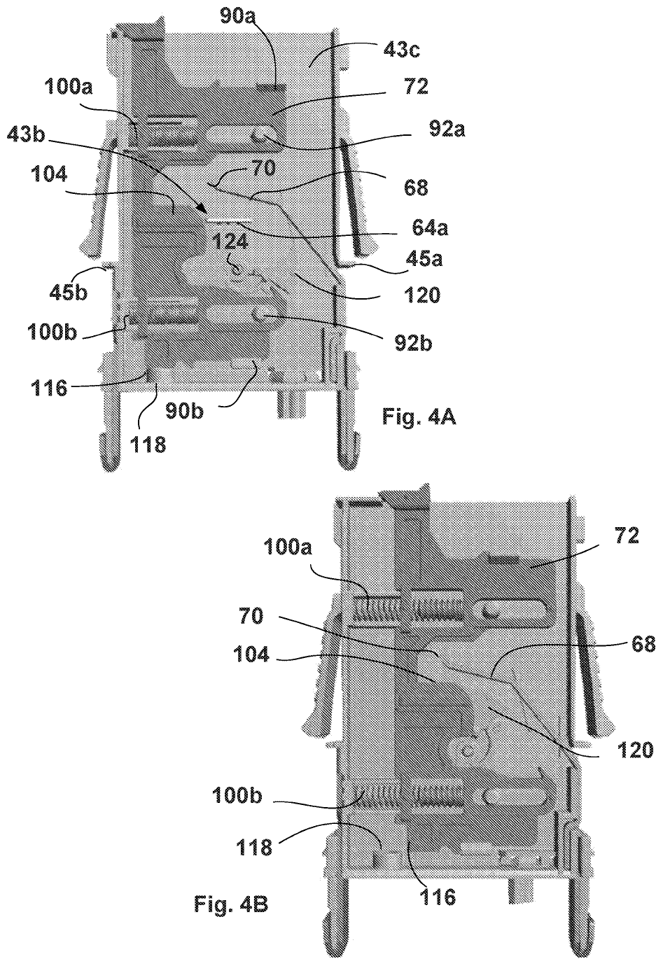

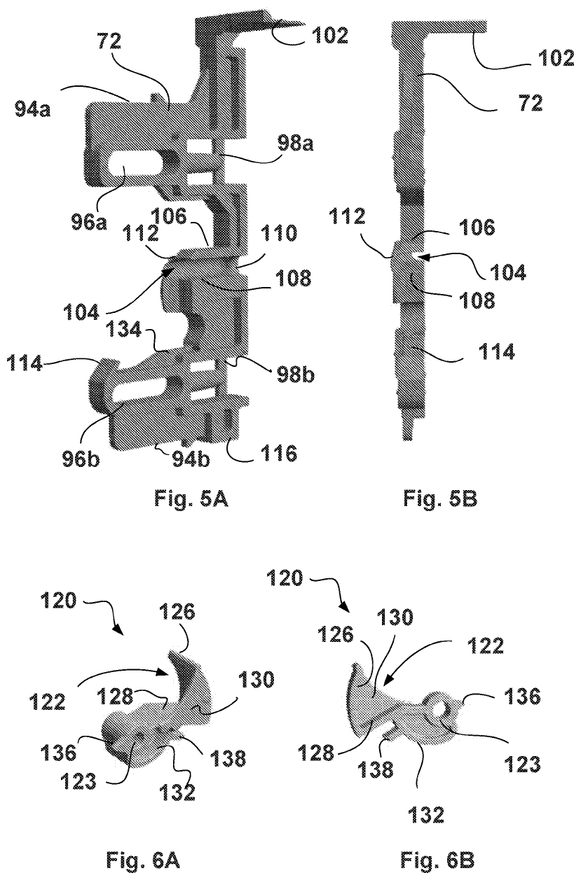

Moving back to FIG. 2A and with additional reference to FIGS. 4A, 4B, 5A and 5B, the cartridge member 12 includes the aforementioned slider 72 movably attached to the cartridge support 42, the slider 72 movable relative to the cartridge support 42 between a first position and a second position. More particularly, the cartridge support 42 includes a pair of retainers 90a, 90b that define a channel along which the slider 72 may move, and guide pins 92a, 92b that guide movement of the slider 72 along the channel. The retainers 90a, 90b extend perpendicularly out from the cartridge support 42 and each retainer includes a respective hook portion, where the hook portions oppose one another and define the channel. The slider 72 includes a pair of opposing rail portions 94a, 94b that are parallel to each other, the rail portions configured to ride within the channel defined by the retainers 90a, 90b. Additionally, a pair of guide slots 96a, 96b are formed in the slider 72, the guide slots 96a, 96b cooperating with the guide pins 92a, 92b of the cartridge support 42 to further guide the slider 72 as it moves relative to the cartridge support 42 (the slider 72 moves linearly between a first position and a second position). The retainers 90a, 90b and guide pins 92a, 92b in combination with the rail portions 94a, 94b and the guide slots 96a, 96b enable the slider 72 to move laterally along a plane defined by the wall of the support 42 but prevent perpendicular movement of the slider 72 relative to the plane defined by the wall of the cartridge support 42.

The slider 72 further includes at least one and preferably a pair of support rods 98a, 98b (best seen in FIG. 5A) for receiving a respective biasing member 100a, 100b, such as a compression spring or the like. The biasing members 100a, 100b mount on the rods 98a, 98b and apply a force to the slider 72 that tends to urge the slider 72 from a first “ready” position to a second “covered” position (the slider 72 is urged toward the electrode 64a of the overvoltage clamping element 80) as described in more detail below. The slider 72 is held in the first “ready” position by the lip 70 formed on one end of the biased conductor 68. For example, under normal operation the biased conductor 68 is retained to the electrode 64 by a solder connection. The lip 70 of the biased conductor 70 abuts against the slider 72 and prevents lateral movement of the slider toward the electrode 64a. Upon the solder melting (e.g., due to excessive heat from the overvoltage clamping element), the biased member 68 is released from the electrode 64a and moves upward such that the lip 70 disengages from the slider 72. With the lip 70 no longer retaining the slider 72, the bias provided by the biasing members 100a, 100b moves the slider 72 toward the electrode 64a and into the second (covered/enclosed) position).

The slider may optionally include an indicator 102 arranged, for example, along a top portion of the slider 72, where the indicator is visible through a window 40a of the housing 40 (the window is best seen in FIG. 1B). For example, when the slider 72 is in a first position, the indicator 102 is visible through window 40a, and when the slider 72 is in a second position the indicator is not visible (or vice-versa). The indicator may be color-coded (e.g., green in the ready state, red in the tripped state) to aid in determining a position of the slider. Thus, by viewing the window 40a one can determine a position of the slider 72 and thus a state of the cartridge member 12 (e.g., ready/normal state or tripped/fault state).

The cartridge member 12 optionally includes an arc shield for reducing and/or eliminating an arc that may be generated when the voltage suppression device 64 is disconnected from a circuit (i.e., when the thermal disconnect mechanism 66 and/or the weak region 88 open the circuit). In its simplest form, the arc shield is partially formed by a support member having a wall, e.g., a wall 43a of the cartridge support 42 and a portion of the slider 72. The support member includes a mount, e.g., wall 43a, the mount 43a configured to receive the voltage suppression device 64. The mount 43a further includes a through-hole 43b for receiving the electrode 64a to be shielded. For example, the voltage suppression device 64 may be mounted to one side of the cartridge support 42 (e.g., on wall 43a), and the electrode 64a may pass through the through-hole 43b and extend out the opposite wall 43c of the cartridge support 42. A shield is attached to the support member on the wall 43c and is movable relative to the support member between a first position and a second position. When the shield is in the second position the electrode 64a is enclosed by the shield and the wall such that all sides of the exposed electrode are covered.

In the illustrated embodiment, the slider 72 includes at least a portion of the arc shield, which is in the form of a hood or hood part 104 having a first (top) wall 106, a second (bottom) wall 108 opposing the first wall 106, a back wall 110 joining the first wall to the second wall, and a sidewall 112 joining the top, bottom and back walls. In the illustrated embodiment, and best be seen in FIG. 5A, the back wall 110 is a partial back wall that does not fully extend to the wall 43a, resulting in the hood or hood part 104 being open on a first (front) side, partially open on a second (back) side, and enclosed on all other sides. Such configuration allows air to exit a back side of the hood/hood part 104 as the slider moves from the ready position to the tripped position. However, in an alternative embodiment the back wall 110 may fully extend toward to the wall 43a such that the hood/hood part 104 is enclosed on all sides except the first (front) side. Additionally, in the illustrated embodiment, the side wall 122 is a curved shape/semi-circular shape, although the side wall may be formed as a planar wall, if desired. As the slider moves to the “second” position, the hood part 104 covers and/or encloses the electrode 64a to isolate the electrode from the biased conductor 68, thereby preventing and/or eliminating an arc between the two as they disconnect from one another.

While the hood part 104 is shown has having an open end adjacent to the electrode 64a (the end adjacent the electrode 64a referred to as the “electrode end”), with the exception of the portion of the hood part 104 immediately adjacent the wall, the hood part 104 may be closed on all sides and have a slot formed in the electrode end, the slot corresponding to the electrode 64a. As the slider 72 moves from the ready position to the enclosed position the hood part 104 receives the electrode 64a through the slot, resulting in the electrode 64a effectively being enclosed on all sides by the hood part 104 in combination with the wall 43c.

The slider 72 also includes a catch member 114 (FIGS. 5A and 5B) disposed on one end of the slider. As described in more detail below, the catch member 114, which in the illustrated embodiment is in the form of a latch, cooperates with a rotatable member to prevent rotation of the rotatable member when the slider 72 is in the ready position. The slider 72 also includes a rejection element 116 that moves with the slider 72 and is operative to cover or expose a pin receiver 118 of the cartridge member 12. The covered position of the pin receiver 118 is illustrated in FIG. 4A (i.e., where the rejection element 116 covers the pin receiver 118) and the exposed position of the pin receiver 118 is illustrated in FIG. 4B (i.e., where the rejection element 116 is moved to the right and the pin receiver 118 is open). The pin receiver 118 accepts the plunger 31 of the base member 14 and, based on the position of the slider 72, the rejection element 116 presses or releases the plunger 31. Thus, based on the position of the slider 72, the plunger 31 can operate a switch to provide a status indication of the cartridge member 12 (e.g., ready or tripped).

With continued reference to FIG. 2A and additional reference to FIGS. 6A and 6B, the cartridge member 12 may optionally include a rotatable member 120 that has a second hood part 122 that cooperates with the first hood part 104 to form an enclosure with the wall 43a. The rotatable member 120 includes a pin receiver 123 that is rotatably attached to a pin 124 of the support member 42, where the rotatable part rotates about the pin 124 between a first angular position and a second angular position. The first angular position corresponds to a “ready” state, while the second angular position corresponds to “covered” and/or “enclosed” state. The second hood part 122 is defined by a first wall 126, a second wall 128, and a sidewall 130 joining the first wall 126 to the second wall 128. In the illustrated embodiment, the first wall and the second wall are not parallel to each other.

The rotatable member 120 further includes an arcuate surface 132 that cooperates with a ramp portion 134 arranged on the slider 72 such that movement of the slider 72 causes corresponding movement of the rotatable member 120. More specifically, as the slider 72 moves from the first “ready” position to the second “covered” and/or “enclosed” position, the ramp portion 134 contacts the arcuate surface 132 and pushes the rotatable member 120 such that it rotates about the pin 124, and as both move to their respective “second” position the first hood part 104 and the second hood part 122 form an enclosure around the electrode 64a. A mechanical stop 136 is arranged on the rotatable member 120, the mechanical stop 136 configured to limit an angular orientation of the rotatable member 120. In this regard, as the rotatable member 120 rotates the mechanical stop 136 eventually contacts a surface of the slider 72 such that further rotation is inhibited.

The rotatable member 120 also includes a catch member 138 that cooperates with the catch member 114 of the slider 72. More specifically, when the slider 72 is in the first “ready” position, catch member 114 of the slider 72 catches the catch member 138 of the rotatable member 120 and prevents rotation of the rotatable member 120. As the slider 72 moves toward the “second” position, the catch member 114 releases from the catch member 138 of the rotatable member 120 thus enabling rotation of the rotatable member 120.

In use, the cartridge member 12 is inserted into the base member 14, whereby the cartridge terminals 62a, 62b electrically connect to the base terminals 26a, 26b, respectively. As the cartridge member 12 is inserted into the base member 14, the actuators 48a, 48b are pressed inward and the latches 50a, 50b are moved inward and into the U-shape channel 18 of the base member 14. Upon the actuators being released, the latches 50a, 50b move outward and into the receivers 20a, 20b, respectively, thereby securing the cartridge member 12 to the base member 14. Once inserted, the terminals 62a, 62b of the cartridge member 12 connect to the terminals 26a, 26b of the base member 14 (and thus to the first and second connection terminals). To remove the cartridge member 12 from the base member 14, a user simply grasps the actuators 48a, 48b and presses them inwards. The inward movement of the actuators 48a, 48b causes corresponding movement of the latches 50a, 50b such that the latches disengage from the receivers 20a, 20b. Once the latches have disengaged from the receivers 20a, 20b, the cartridge member can be removed from the base member 14.

Modifications and alterations of the structures shown in the drawings will become apparent to those skilled in the art after reading the present specification. It is intended that all such modifications and all variations being included in so far as they come within the scope of the patent as claimed or the equivalence thereof.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

1. A voltage suppression device for suppressing voltage surges in an electrical circuit, comprising an overvoltage clamping element having a first electrode and a second electrode, the first electrode and the second electrode operative to pass power through the overvoltage clamping element, wherein at least one electrode of the first electrode or the second electrode includes a region having reduced cross-section relative to other regions of the respective electrode.

2. The device according to claim 1, wherein the at least one electrode is integrally formed with the overvoltage clamping element.

3. The device according to claim 1, wherein the overvoltage clamping element and the at least one electrode are formed as a unitary structure.

4. The device according to claim 1, where in response to a current through the at least electrode exceeding a predetermined threshold current the region of reduced cross section electrically disconnects a portion of the at least one electrode from another portion of the at least one electrode.

5. The device according to claim 1, wherein the overvoltage clamping element comprises a varistor, gas discharge tube, spark gap, or diode.

6. The device according to claim 1, wherein the overvoltage clamping element has a first planar side and a second planar side opposing the first planar side, and the first electrode is connected to the first planar side and the second electrode is connected to the second planar side.

7. The device according to claim 1, wherein the at least one electrode includes a connection region for electrically connecting the at least one electrode to another device, and the region of reduced cross section is arranged between the connection region and a body of the overvoltage clamping element.

8. The device according to claim 1, wherein the overvoltage clamping element comprises at least one of a disk-shape, a rectangular shape or a cylindrical shape.

9. The device according to any one of claim 1, further comprising an arc shield for suppressing an electrical arc, the arc shield comprising:
a support member including a wall;
a mount arranged on the wall, the mount configured to receive one of the first electrode or the second electrode of the overvoltage clamping element; and
a shield attached to the support member and movable relative to the support member between a first position and a second position, wherein when the shield is in the second position the one of the first electrode or the second electrode is enclosed by the shield and the wall.

10. The device according to claim 9, wherein the shield comprises a first hood part mounted on a slider and a second hood part mounted on a rotatable member, the slider and the rotatable member independent from one another, wherein
the slider is attached to the support member and movable relative to the support member between a first slider position and a second slider position, and
the rotatable member is attached to the support member and rotatable between a first angular position and a second angular position.

11. The device according to claim 10, wherein the slider is configured to move linearly between the first position and the second position.

12. The device according claim 10, wherein movement of the slider causes corresponding movement of the rotatable member.

13. The device according to claim 12, wherein the rotatable member comprises an arcuate surface and the slider comprises a ramp portion that cooperates with the arcuate surface, and movement of the slider causes the ramp portion apply a force to the arcuate surface and push the rotatable member about an axis of rotation of the rotatable part.

14. (canceled)

15. The device according to claim 10, wherein the rotatable member includes a mechanical stop configured to limit an angular orientation of the rotatable member.

16. The device according to claim 10, wherein the slider includes a first catch member and the rotatable member includes a second catch member, the first catch member and the second catch member configured to cooperate with each other to prevent rotation of the rotatable member when the slider is in the first position.

17. The device according to claim 10, wherein the second hood part comprises a first wall, a second wall, and a sidewall joining the first wall to the second wall, wherein the first wall and the second wall are non-parallel to each other.

18. The device according to claim 10, wherein the first hood part comprises a first wall, a second wall opposing the first wall, and a sidewall joining the first wall to the second wall.

19. The device according to claim 9, further comprising a biasing member coupled to the shield, the biasing member operative to bias the shield toward the second position.

20-31. (canceled)
